(19) United States
(12) Patent Application Publication
(10) Pub. No.: US 2014/0376995 A1
(43) Pub. Date: Dec. 25, 2014

(54) Air-tight Slip-on Structural Joint Not Using Sealant

(71) Applicant: Tesla Motors, Inc., Palo Alto, CA (US)

(72) Inventors: Andreas Faass, San Francisco, CA (US); Aaron Johnson, Palo Alto, CA (US); Derek Ryan Paul, Menlo Park, CA (US); Donald James Parr, San Francisco, CA (US); Kevin Matthew Anderson, Mountain View, CA (US)

(73) Assignee: Tesla Motors, Inc., Palo Alto, CA (US)

(21) Appl. No.: 13/922,905

(22) Filed: Jun. 20, 2013

(51) Int. Cl. B32B 37/12; B32B 37/18; F16B 11/00

(52) U.S. Cl. CPC B32B 37/1284; F16B 11/008; B32B 37/18
USPC 403/267; 403/270; 156/305

(57) ABSTRACT

A method includes: assembling first and second pieces in a slip-fit joint without applying adhesive or sealant, wherein the first piece covers a portion of the second piece in the slip-fit joint; and injecting adhesive through the first piece until the adhesive fills a gap of the slip-fit joint, wherein the adhesive makes the slip-fit joint air tight without applying the sealant. An air-tight slip-fit joint consists essentially of: first and second pieces assembled without applying adhesive or sealant, wherein the first piece covers a portion of the second piece in the slip-fit joint; and adhesive injected through the first piece until the adhesive fills a gap of the slip-fit joint, wherein the adhesive makes the slip-fit joint air tight without applying the sealant.

### BACKGROUND

Welding is often used to join metallic structural members to each other. For example, a hollow aluminum extrusion is sometimes welded to an adjacent member in an attempt to create a leak-tight joint that can support high structural loads. However, the material choices for such joints are typically limited to metals. Moreover, the adjacent members must be of the same metal type for efficient welding. High amounts of heat are typically applied, which can distort individual component parts or the entire assembly. Also, it is often necessary to test virtually all welded joints for acceptable leak-down performance, because a number of possible factors—environmental, process related and intrinsic to the parts—can lead to a faulty seal in any individual joint.

Another example is that a slip-fit mechanical joint is prepared by first applying adhesive to one or more parts that are to be slid against each other in assembling the component. However, the sliding action often pushes adhesive out of the bond area which can lead to poor structural integrity. In addition, the sliding action can create voids (e.g., bubbles) in the adhesive layer, and such voids deteriorate the seal quality. For this reason, this type of slip-fit joints often has a sealant separately applied later in the assembly process.

### SUMMARY

In a first aspect, a method comprises: assembling first and second pieces in a slip-fit joint without applying adhesive or sealant, wherein the first piece covers a portion of the second piece in the slip-fit joint; and injecting adhesive through the first piece until the adhesive fills a gap of the slip-fit joint, wherein the adhesive makes the slip-fit joint air tight without applying the sealant.

Implementations can include any or all of the following features. At least one of the first and second pieces has stand-off ribs that create the gap of the slip-fit joint. The adhesive is injected through an injection port of the first piece until the adhesive is visible in a weep hole of the first piece. The second piece comprises a hollow aluminum extrusion, wherein the first piece comprises an interior lug, and wherein assembling the first and second pieces comprises fitting the hollow aluminum extrusion over the interior lug. The method further comprises mechanically fastening the first and second pieces to each other after assembling them in the slip-fit joint and before injecting the adhesive. The method further comprises fixating the first and second pieces in a fixture before injecting the adhesive.

In a second aspect, an air-tight slip-fit joint consists essentially of: first and second pieces assembled without applying adhesive or sealant, wherein the first piece covers a portion of the second piece in the slip-fit joint; and adhesive injected through the first piece until the adhesive fills a gap of the slip-fit joint, wherein the adhesive makes the slip-fit joint air tight without applying the sealant.

Implementations can include any or all of the following features. At least one of the first and second pieces has stand-off ribs that create the gap of the slip-fit joint. The adhesive is injected through an injection port of the first piece until the adhesive is visible in a weep hole of the first piece. The second piece comprises a hollow aluminum extrusion, wherein the first piece comprises an interior lug, and wherein assembling the first and second pieces comprises fitting the hollow aluminum extrusion over the interior lug. The first and second pieces are mechanically fastened to each other after being assembled in the slip-lit joint and before the adhesive is injected. The first and second pieces are fixated in a fixture before the adhesive is injected.

### BRIEF DESCRIPTION OF DRAWINGS

FIG. 1 shows an example of a component assembled using an air-tight slip-fit joint between a first piece and a second piece.

FIG. 2 shows a partial cross section of the component in FIG. 1.

FIG. 3 shows a portion of the partial cross section in FIG. 2.

FIGS. 4A-D show an example of creating an air-tight slip-fit joint.

### DETAILED DESCRIPTION

This document describes systems and techniques for creating an air-tight structurally sound slip-on joint using adhesive, without applying a sealant. In a particular implementation, two pieces are assembled in a slip-fit joint. One of the pieces covers a portion of the other piece. At this point in the assembly, adhesive or sealant is not applied. Next, adhesive is injected through an injection port in the one outward facing piece, for example until the adhesive emerges from a weep hole. When the adhesive has set, the adhesive makes the slip-fit joint air tight without any sealant being applied.

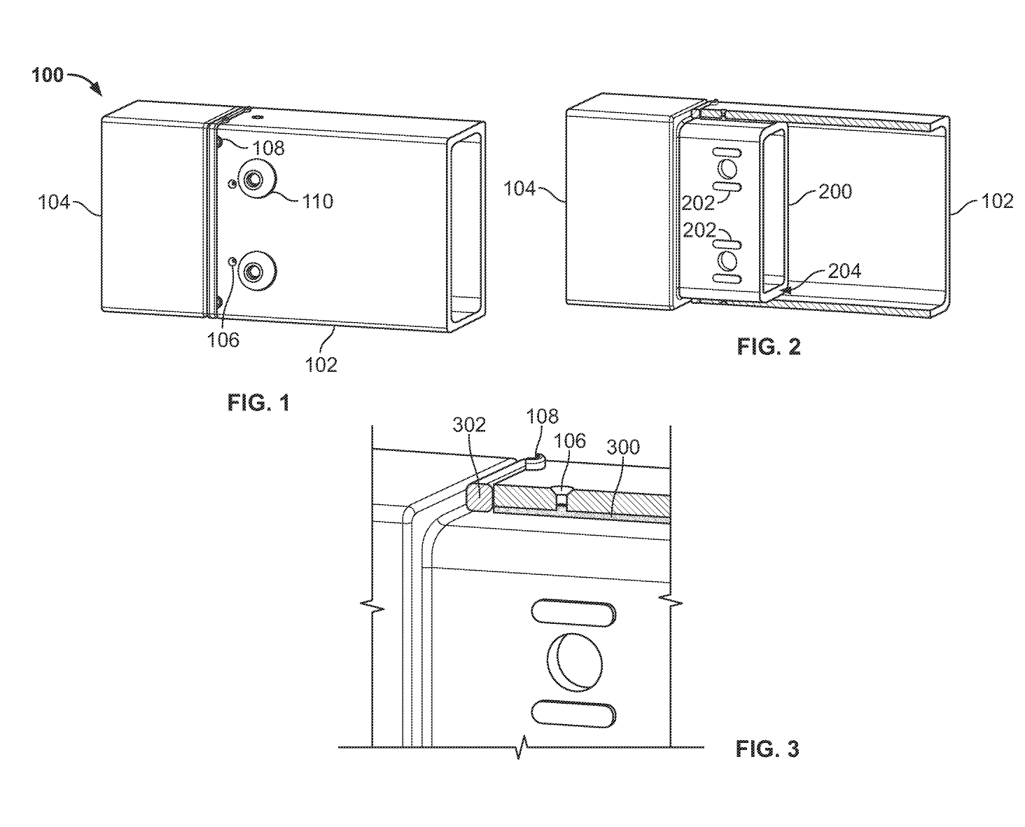

FIG. 1 shows an example of a component 100 assembled using an air-tight slip-fit joint between a first piece 102 and a second piece 104. On the first piece, one or more adhesive injection ports 106, and one or more weep holes 108, can be provided. Mechanical fasteners 110 (e.g., bolts or screws) can attach the pieces to each other before the adhesive is applied.

FIG. 2 shows a partial cross section of the component 100 in FIG. 1. Particularly, a portion of the first piece 102 has been removed for illustrative purposes. This reveals that the second piece 104 has an interior lug 200 that fits into the hollow interior of the first piece. For example, the first piece can be an extrusion component (e.g., from aluminum). The second piece here has one or more stand-off ribs 202 on the interior lug. This can create a gap 204 between the first and second pieces. For example, effective bonding and sealing can depend on there being a consistent gap between the first and second pieces.

In some implementations, one or more other materials can be used instead of, or in combination with, an aluminum extrusion. For example, and without limitation, a machined piece (e.g., of steel) or a molded piece (e.g., of plastic) can be used.

FIG. 3 shows a portion of the partial cross section in FIG. 2. Here, adhesive has been injected through one or more of the injection ports 106, creating an adhesive layer 300 between the first and second pieces. When enough adhesive has been injected, adhesive emerges from—or is visible through—the weep hole(s) 108. One or more structures in the gap can facilitate the flow of adhesive. In some implementations, an adhesive seal gasket 302 is applied around the perimeter of the interior lug. For example, the adhesive can flow, under pressure from the injection nozzle, from the injection port along the gap until being redirected by the adhesive seal gasket. When the adhesive reaches the weep hole, it can emerge therethrough, which can be a signal to discontinue the injection. In another implementation, the perimeter of the interior lug near the weep hole(s) can be sealed in another way (e.g., by a structure integral to the first or second piece).

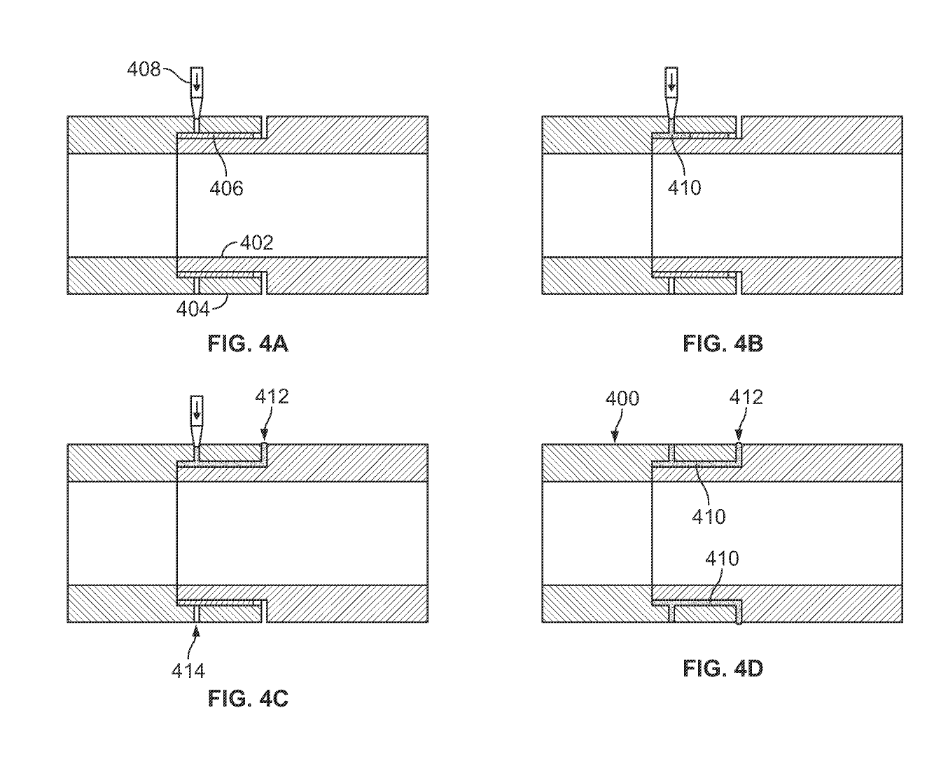

FIGS. 4A-D show an example of creating an air-tight slip-fit joint 400. In FIG. 4A, parts A and B have been dry slip-on fitted to each other. For example, part B can have an interior lug 402, and part A can have a hollow portion 404, for example with one or more stand-off ribs 406. An adhesive injection nozzle 408 is currently fitted into an injection port.

In FIG. 4B, adhesive 410 begins to be injected under pressure and starts to fill the gap between the pieces. For example, and without limitation, the type of adhesive used can be a two part methylmethacrylate-based structural adhesive. As another example, a structural epoxy adhesive can be used.

In FIG. 4D, adhesive begins to emerge in a weep hole 412. This can indicate to the operator that enough adhesive has been injected. A similar process can be performed on one or more other sides 414 of the assembly.

In FIG. 4D, the air-tight slip-fit joint 400 is complete, and provides a structurally sound and leak-proof attachment between the two pieces. Particularly, because the adhesive 410 thoroughly fills the gap between the pieces, there is no need to apply any separate sealant over the injection port(s), the weep hole(s) 412, or the interface or seam between the pieces.

A number of implementations have been described as examples. Nevertheless, other implementations are covered by the following claims.

What is claimed is:

1. A method comprising:
assembling first and second pieces in a slip-fit joint without applying adhesive or sealant, wherein the first piece covers a portion of the second piece in the slip-fit joint; and
injecting adhesive through the first piece until the adhesive fills a gap of the slip-fit joint, wherein the adhesive makes the slip-fit joint air tight without applying the sealant.

2. The method of claim 1, wherein at least one of the first and second pieces has stand-off ribs that create the gap of the slip-fit joint.

3. The method of claim 1, wherein the adhesive is injected through an injection port of the first piece until the adhesive is visible in a weep hole of the first piece.

4. The method of claim 1, wherein the second piece comprises a hollow aluminum extrusion, wherein the first piece comprises an interior lug, and wherein assembling the first and second pieces comprises fitting the hollow aluminum extrusion over the interior lug.

5. The method of claim 1, further comprising mechanically fastening the first and second pieces to each other after assembling them in the slip-fit joint and before injecting the adhesive.

6. The method of claim 1, further comprising fixating the first and second pieces in a fixture before injecting the adhesive.

7. An air-tight slip-fit joint consisting essentially of:
first and second pieces assembled without applying adhesive or sealant, wherein the first piece covers a portion of the second piece in the slip-fit joint; and
adhesive injected through the first piece until the adhesive fills a gap of the slip-fit joint, wherein the adhesive makes the slip-fit joint air tight without applying the sealant.

8. The air-tight slip-fit joint of claim 7, wherein at least one of the first and second pieces has stand-off ribs that create the gap of the slip-fit joint.

9. The air-tight slip-fit joint of claim 7, wherein the adhesive is injected through an injection port of the first piece until the adhesive is visible in a weep hole of the first piece.

10. The air-tight slip-fit joint of claim 7, wherein the second piece comprises a hollow aluminum extrusion, wherein the first piece comprises an interior lug, and wherein assembling the first and second pieces comprises fitting the hollow aluminum extrusion over the interior lug.

11. The air-tight slip-fit joint of claim 7, wherein the first and second pieces are mechanically fastened to each other after being assembled in the slip-fit joint and before the adhesive is injected.

12. The air-tight slip-fit joint of claim 7, wherein the first and second pieces are fixated in a fixture before the adhesive is injected.
